(19) United States
(12) Patent Application Publication
(10) Pub. No.: US 2004/0014872 A1
(43) Pub. Date: Jan. 22, 2004

(54) Bonding agent composition containing solid matter, with radically polymerised block copolymers

(76) Inventor: Roman Benedikt Raether, Limburgerhof (DE)

Correspondence Address: KEIL & WEINKAUF, 1350 CONNECTICUT AVENUE, N.W., WASHINGTON, DC, 20036, US

(21) Appl. No.: 10/311,374

(22) PCT Filed: Jun. 13, 2001
(86) PCT No.: PCT/EP01/06707

(30) Foreign Application Priority Data
Jun. 16, 2000 (DE) 10029697.1

(51) Int. Cl. C08L 23/00

(52) U.S. Cl. 524/543

(57) ABSTRACT

A binder composition, at least containing a block copolymer which can be prepared by free radical polymerization and comprises at least two blocks of different monomer compositions, and at least 2% by weight of at least one nonmagnetic and nonmagnetizable inorganic or organic solid, a process for the preparation of such a binder composition and its use are described.

The present invention relates to a binder composition, at least containing a block copolymer which can be prepared by free radical polymerization and comprises at least two blocks of different monomer compositions, and at least 2% by weight of at least one nonmagnetic and nonmagnetizable inorganic or organic solid, a process for the preparation of such a binder composition and its use.

Binder compositions are frequently used for coating surfaces or for adhesively bonding different substrates or as fillers for leveling out irregularities in surfaces or for repairing defects in material surfaces, for example for repairing automotive bodywork parts. Often, the corresponding coatings, adhesive bonds or repairs have to meet high requirements with respect to strength and resistance to external influences. Such requirements can frequently be fulfilled only when the binder compositions comprise fillers, for example organic or inorganic solids. In addition, surface coatings are frequently used for the decorative coating of substrates. Such coatings often comprise color-imparting pigments. In all cases stated, it is necessary for the corresponding fillers or pigments to be very uniformly distributed in the binder. On the one hand, this ensures uniformity of the properties of such a coating over the entire coated surface and, on the other hand, particularly if such a coating contains color-imparting pigments, a uniform distribution of such pigments in the coat contributes to an improved visual impression of the coat.

A further requirement of such binders is that the fillers or pigments distributed, for example dispersed, in such a binder be dispersed in a stable manner over a very long period. It may even be advantageous to disperse a very large amount of fillers or pigments in a binder, for example in order to utilize specific advantageous properties of the fillers or pigments or, in the case of pigments, in order to achieve a very high degree of coloring.

As a rule, such an increase in the proportion of fillers or pigments is associated with a reduction in the proportion of binders. However, this can lead to a reduction in the stability of the dispersions of such fillers or pigments in a corresponding binder, with the result that the abovementioned, desired properties may be adversely affected.

Moreover, especially if they are exposed particularly frequently to extreme conditions, for example temperature changes, high-energy radiation or mechanical loads, corresponding surface coatings should have very high resistance to such loads.

To achieve a very good distribution of fillers or pigments in a binder, low molecular weight dispersants have in the past frequently been added in small amounts to such a binder to facilitate such dispersing of fillers or pigments in binders. However, such low molecular weight dispersants have disadvantages. For example, under unfavorable climatic conditions, such as high atmospheric humidity or high temperature, they may readily be exuded, i.e. emerge at the surface of a corresponding surface coating, with the result that the external appearance is generally impaired. If such a migration of dispersants occurs, for example in adhesive bonds, this may result in a reduction in the adhesive power.

Furthermore, incompatibilities between specific fillers or specific pigments and binders have frequently been observed in the past. Such incompatibility is often caused by the different polarity of fillers or pigments and the corresponding binder. Since fillers or pigments are often hydrophilic, while binders frequently have hydrophobic properties, separation phenomena can therefore occur at as early a stage as the distribution of the fillers or pigments in the binders (dispersing process), with the result that the abovementioned, disadvantageous properties are produced. Particularly in the case of fillers which are intended to impart mechanical strength to the binder, the compatibility between binder and filler is an elementary requirement since only a strong bond between filler and binder can result in corresponding mechanical strength of the binder.

In the past, such problems were frequently counteracted by incorporating ionic groups or nonionic hydrophilic groups into a binder. However, this can lead to the corresponding binders having increased water sensitivity and being no longer capable of use under moist conditions.

For the preparation of binder compositions having a high filler content, polyadducts or polycondensates have frequently been used in the past. Such compounds generally make it possible to have an excellent effect on the binders present in the binder composition and their properties as early as during the synthesis of such binders. Owing to the stepwise synthesis of such binders, it is possible, for example, to realize block structures which usually contribute to better dispersing of fillers or pigments in binders and can impart, for example, greater strength to a surface coating produced with the aid of such a binder. However, the disadvantage of such binders is the fact that it is often necessary to resort to the complexity of a multistage synthesis for their preparation. Particularly in the case of polyadducts, which are frequently prepared by reactions of polyisocyanates with corresponding compounds reactive toward polyisocyanates, the handling of the toxic polyisocyanates may be mentioned as a disadvantage. Moreover, such binders generally have poorly controllable, high polydispersity.

In comparison, the preparation of random copolymers by free radical polymerization constitutes a substantial simplification of the process. However, the products forming are poorly controllable in their physical or chemical properties and it is generally not possible to establish such properties specifically.

The known processes for the free radical preparation of polymers do not permit sufficiently specific establishment of degree of polymerization, block length distribution, polydispersity or block structure. Consequently, valuable properties, such as dispersing effect, flow behavior or mechanical strength, can be established only incompletely, if at all. The known binders which can be prepared by free radical polymerization therefore require either additional use of low molecular weight dispersants, the abovementioned adverse properties being displayed, or the incorporation of monomers having functional groups which act as ionic or other polar anchor groups and can interact with the filler surface or pigment surface. However, as also outlined above, this is not a satisfactory solution to the problem discussed. On the one hand, the incorporation of such monomers which have a polar group can be only incompletely controlled in the known binders which can be prepared by free radical polymerization; on the other hand, monomers having anchor groups which permit a desired establishment of the interaction of the binder with the filler surface or pigment surface are often obtainable only with difficulty.

There was therefore a need for binder compositions which do not have the abovementioned disadvantages of the prior art.

It is an object of the present invention to provide filler- or pigment-containing binder compositions which comprise binders which can be easily prepared by free radical polymerization but have an excellent dispersing effect, excellent physical and mechanical properties and suitable long-term behavior. In particular, it is an object of the present invention to provide a binder composition which has the abovementioned advantages even with relatively high contents of fillers or pigments, for example more than about 2% by weight. Furthermore, it is an object of the present invention to provide a binder composition which permits dispersing of pigment in water, the binder being self-dispersing in water.

We have found that this object is achieved by a binder composition which contains at least one block copolymer which can be prepared by free radical polymerization and at least 2% by weight of a nonmagnetic and nonmagnetizable particulate inorganic or organic solid.

The present invention therefore relates to a binder composition, at least containing a block copolymer which can be prepared by free radical polymerization and comprises at least two blocks of different monomer compositions, and at least 2% by weight of at least one nonmagnetic and nonmagnetizable inorganic or organic solid.

In the context of the present invention, a binder composition is understood as meaning a mixture which contains at least one block copolymer which can be prepared by free radical polymerization and comprises at least two blocks of different monomer compositions, and additionally at least 2% by weight of a nonmagnetic and nonmagnetizable inorganic or organic solid. A novel binder composition can moreover contain further additives, as described further below in this text.

In the context of the present invention, a block copolymer is understood as meaning a polymer,which comprises at least two polymer blocks characterized by different monomer compositions. In the context of the present invention, different monomer compositions is understood as meaning that at least two regions of the block copolymer comprise at least two blocks having different monomer compositions. Within the scope of the present invention, it is possible that the transition between two blocks is continuous, i.e. a zone which has a random or regular sequence of the monomers constituting the blocks exists between two blocks. Within the scope of the present invention, it is however also envisaged that the transition between two blocks is essentially discontinuous. An essentially discontinuous transition is understood as meaning a transition zone which has a substantially shorter length than at least one of the blocks separated by the transition zone. In a preferred embodiment of the present invention, the chain length of such a transition zone is less than 1/10, preferably less than 1/20, of the block length of at least one of the blocks separated by the transition zone.

In the context of the present invention, different monomer compositions is understood as meaning that the monomers constituting the respective blocks differ in at least one feature, for example in their linking to one another, in their conformation or in their constitution. Block copolymers which comprise at least two blocks whose monomer compositions differ at least in the constitution of the monomers are preferably used in the present invention.

The block copolymers which can be used in the present invention have, in a preferred embodiment, a polydispersity of less than about 5, for example less than about 4 or less than about 3.

The molecular weight of the block copolymers which can be used in the present invention is as a rule at least about 1000, but preferably higher, for example 2000, 4000, 8000 or 10,000. Depending on the desired mechanical properties of the products which can be prepared with the aid of the novel binder composition, block copolymers which have a molecular weight of more than 20,000, for example more than 40,000, more than 60,000 or more than 80,000, can be used in the present invention. It may be advantageous to use block copolymers whose molecular weight exceeds 100,000 and is, for example, up to about 500,000 or about 1,000,000. In rare cases, block copolymers having a molecular weight above about 1,000,000 can also be used in the novel binder composition.

In the context of the present text, the molecular weight is understood as meaning the value for Mw as obtainable by GPC under the following conditions:

Eluent: THF, standard: polystyrene, Waters unit, UV detector: Waters 410, RI detector: Waters 481, pump: 510; columns: crosslinked polystyrene (measuring range: 500-100,000 g/mol) from PSS (Mainz).

The block copolymers which can be used in the binder compositions according to the present invention are prepared by free radical polymerization. A process for the preparation of the block copolymers which can be used in the novel binder compositions takes place in at least two stages, according to the desired number of blocks. Depending on the desired number of blocks, however, more stages may also be employed. If it is intended to prepare, for example, a block copolymer comprising four blocks, as a rule four stages are required for the preparation of a corresponding polymer. A corresponding situation applies to a larger or smaller number of blocks. The number of stages required is as a rule identical to the number of blocks obtained in the block copolymer.

In a preferred embodiment of the invention, the block copolymer is prepared by a process at least comprising the following stages (i) and (ii):

(i) reaction, under free radical conditions, of a reaction mixture comprising

at least one monomer (a) capable of free radical polymerization,

at least one free radical initiator and

a compound of the formula (I)

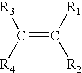

where R1 to R4, independently of one another in each case, are hydrogen, an in each case unsubstituted or substituted alkyl radical, cycloalkyl radical, aralkyl radical, an unsubstituted or substituted aromatic hydrocarbon radical, with the proviso that at least two of the radicals R1 to R4 are an unsubstituted or substituted aromatic hydrocarbon radical, or R1 and R2 or R3 and R4, in pairs in each case, form a substituted or unsubstituted aromatic hydrocarbon having 6 to 18 carbon atoms and a functional group which has, conjugated with the C—C double bond in the formula I, a multiple bond between a carbon atom and a hetero atom, a reaction product (A) being obtained, and

(ii) reaction of the reaction product (A) obtained in stage (i), under free radical conditions, with at least one monomer (b) capable of free radical homopolymerization or copolymerization, a reaction product (B) being obtained.

In stage (i) of the process described above, all monomers capable of free radical reaction can be used as monomers (a).

For example, compounds which are capable of free radical homopolymerization or copolymerization and comprise a hydrophilic group, e.g. a carboxyl, sulfo or phosphoric acid group, can be used as monomers (a). In this case, the monomers (a) are hydrophilic monomers capable of free radical homopolymerization or copolymerization, i.e. monomers whose solubility in water is higher than that of styrene.

It is of course also possible to use mixtures of different hydrophilic monomers as monomers (a) in the present invention.

In a further embodiment of the present invention, however, it is also possible to use monomers capable of free radical polymerization which have a water solubility which corresponds to or is even lower than that of styrene.

Moreover, mixtures comprising at least one hydrophilic monomer and at least one hydrophobic monomer can also be polymerized by the abovementioned process. Specific examples of monomers (a) are:

C1- to C20-alkyl and hydroxyalkyl esters of monoethylenically unsaturated C3- to C10-monocarboxylic acids or C4- to C8-dicarboxylic acids, for example methyl methacrylate, ethyl methacrylate, propyl methacrylate (all isomers), butyl methacrylate (all isomers), 2-ethylhexyl methacrylate, isobornyl methacrylate, methyl acrylate, ethyl acrylate, propyl acrylate (all isomers), butyl acrylate (all isomers), 2-ethylhexyl acrylate, isobomyl acrylate, benzyl acrylate, phenyl acrylate, stearyl acrylate, diethyl maleate, hydroxyethyl acrylate, hydroxypropyl acrylate or hydroxybutyl acrylate, and furthermore (meth)acrylates of alkoxylated C1- to C18-alcohols which have been reacted with from 2 to 50 mol of ethylene oxide, propylene oxide, butylene oxide or mixtures thereof; benzyl methacrylate, phenyl methacrylate, stearyl methacrylate, methacrylonitrile, styrene, α-methylstyrene, acrylonitrile, functionalized methacrylates; acrylates and styrenes selected from glycidyl methacrylate, 2-hydroxyethyl methacrylate, hydroxypropyl methacrylate (all isomers), hydroxybutyl methacrylate (all isomers), diethylaminoethyl methacrylate, triethylene glycol methacrylate, itaconic anhydride, itaconic acid, glycidyl acrylate, 2-hydroxyethyl methacrylate, diethylaminoethyl acrylate, triethylene glycol acrylate, methacrylamide, N-tert-butylmethacrylamide, N-n-butylmethacrylamide, N-methylolmethacrylamide, N-ethylolmethacrylamide, N-tert-butylacrylamide, N-butylacrylamide, N-methylol-acrylamide, N-ethylolacrylamide, vinylbenzoic acid (all isomers), diethylaminostyrene (all isomers), α-methylvinylbenzoic acid (all isomers), diethylamino-α-methylstyrene (all isomers), p-methylstyrene, p-vinylbenzenesulfonic acid, trimethoxysilylpropyl methacrylate, triethoxysilylpropyl methacrylate, tributoxysilylpropyl methacrylate, diethoxymethylsilylpropyl methacrylate, dibutoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, trimethoxysilylpropyl acrylate, triethoxysilylpropyl acrylate, tributoxysilylpropyl acrylate, dimethoxymethyl-silylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilyipropyl acrylate, vinyl acetate and vinyl butyrate, vinyl chloride, vinyl fluoride, vinyl bromide, vinyl alcohol, vinyl ethers of C1- to C18-alcohols, vinyl ethers of alkoxylated C1- to C18-alcohols and vinyl ethers of polyalkylene oxides, such as polyethylene oxide, polypropylene oxide or polybutylene oxide, monoethylenically unsaturated C3- to C10-monocarboxylic acids, the alkali metal salts and/or ammonium salts thereof, for example acrylic acid, methacrylic acid, dimethylacrylic acid, ethylacrylic acid, allylacetic acid or vinylacetic acid, furthermore monoethylenically unsaturated C4- to C8-dicarboxylic acids, the monoesters, anhydrides, alkali metal salts and/or ammonium salts thereof, for example maleic acid, fumaric acid, itaconic acid, mesaconic acid, methylenemalonic acid, citraconic acid, maleic anhydride, itaconic anhydride or methylmalonic anhydride; furthermore monoethylenically unsaturated monomers, for example allylsulfonic acid, styrenesulfonic acid, 2-acrylamido-2-methylpropanesulfonic acid, methallylsulfonic acid, vinylsulfonic acid, 3-sulfopropyl acrylate or 3-sulfopropyl methacrylate, furthermore monoethylenically unsaturated monomers containing phosphonic acid groups, for example vinylphosphonic acid, allylphosphonic acid or acrylamidoethylpropanephosphonic acid, furthermore amides and N-substituted amides of monoethylenically unsaturated C3- to C10-monocarboxylic acids or C4- to C8-dicarboxylic acids, for example acrylamide, N-alkylacrylamides or N,N-dialkylacrylamides, each having 1 to 18 carbon atoms in the alkyl group, such as N-methylacrylamide, N,N-dimethylacrylamide, N-tert-butylacrylamide or N-octadecylacrylamide, N-monomethylhexylmaleamide, N-monodecylmaleamide, diethylaminopropylmethacrylamide or acrylamidoglycollic acid; furthermore alkylaminoalkyl (meth)acrylates, for example dimethylaminoethyl acrylate, dimethylaminoethyl methacrylate, ethylaminoethyl acrylate, diethylaminoethyl methacrylate, dimethylaminopropyl acrylate or dimethylaminopropyl methacrylate; furthermore vinyl esters, such as vinyl formate, vinyl acetate or vinyl propionate, where these may also be present in hydrolyzed form after the polymerization; furthermore N-vinyl compounds, for example N-vinylpyrrolidone, N-vinylcaprolactam, N-vinylformamide, N-vinyl-N-methylformamide, 1-vinylimidazole or 1-vinyl-2-methylimidazole; furthermore vinyl ethers of C1- to C18-alcohols, vinyl ethers of alkoxylated C1- to C18-alcohols and vinyl ethers of polyalkylene oxides, such as polyethylene oxide, polypropylene oxide or polybutylene oxide, styrene or its derivatives, such as α-methylstyrene, indene, dicyclopentadiene, monomers which carry amino or imino groups, such as dimethylaminoethyl methacrylate, diethylaminoethyl acrylate, diethylaminopropylmethacrylamide or allylamine, monomers which carry quaternary ammonium groups, for example present as salts as obtained by reacting the basic amino finctions with acids, such as hydrochloric acid, sulfuric acid, nitric acid, formic acid or acetic acid, or in quaternized form (examples of suitable quaternizing agents are dimethyl sulfate, diethyl sulfate, methyl chloride, ethyl chloride or benzyl chloride), e.g. dimethylaminoethyl acrylate hydrochloride, diallyldimethylammonium chloride, dimethylaminoethyl acrylate methylchloride, dimethylaminoethylaminopropylmethacrylamide methosulfate, vinylpyridinium salts or 1-vinylimidazolium salts; monomers in which the amino groups and/or ammonium groups are liberated only after the polymerization and subsequent hydrolysis, for example N-vinylformamide or N-vinylacetamide, and mixtures of two or more of the abovementioned monomers.

In a preferred embodiment, a first monomer (a) used comprises styrene or one or more of the abovementioned styrene derivatives, acrylic or methacrylic acid, a C1-C4-alkyl or C1-C4-hydroxyalkyl acrylate or methacrylate, vinyl acetate, one of the abovementioned vinyl ethers or a mixture of two or more thereof, a substituted or unsubstituted vinylpyrrolidone, a mixture of two or more thereof, or a mixture of this first monomer (a′) with at least one further monomer (a) capable of free radical homopolymerization or copolymerization.

According to the invention, a compound (I) of the formula

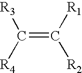

where R1 to R4 have the abovementioned meanings, is used in the preparation of the reaction product (A). In the context of the present invention, a hetero atom is understood as meaning an atom, other than carbon, which is capable of forming multiple bonds (double or triple bonds) with a carbon atom.

In a preferred embodiment of the invention, 1,1-diphenylethene, 1,1-dinaphthylethene, 4,4-vinylidenebis(N,N′-dimethylaniline), 4,4-vinylidenebis(aminobenzene), cis-stilbene, trans-stilbene, methyl α-phenylacrylate, methyl α-phenylmethacrylate, α-phenylacrylonitrile, α-phenylmethacrylonitrile or a mixture of two or more thereof is used as a compound of the formula I. In a further preferred embodiment of the invention, 1,1-diphenylethene is used as a compound of the formula I.

Also suitable as compounds of the formula I are substituted diphenylethenes which are substituted either on one aromatic hydrocarbon radical or on both aromatic hydrocarbon radicals by electron-attracting or electron-shifting substituents, e.g. tert-butyl, benzyl or CN groups, or an alkoxydiphenylethylene, such as methoxy-, ethoxy- or tert-butyloxydiphenylethylene, and the analogous thio or amino compounds.

Stage (i) of the abovementioned process is carried out in the presence of at least one free radical initiator, oxidizing free radical initiators being preferred here. Preferably, the initiator should be soluble in the solvent used or at least in the monomers used for the polymerization. In general, however, all azo and/or peroxo compounds conventionally used in free radical chain polymerization may be employed.

Suitable initiators are described, for example, on page 10, lines 17-34, of WO 98/01478, which is hereby fully incorporated by reference in the context of the present application.

In a preferred embodiment for stage (i) of the abovementioned process, a comparatively large amount of free radical initiator is added, the proportion of free radical initiator into the reaction mixture preferably being from 0.5 to 50, particularly preferably from 1 to 20, % by weight, based in each case on the total amount of the monomer (a) and of the initiator. The ratio of initiator to compound of the formula I is preferably from 3:1 to 1:3, particularly preferably from 2:1 to 1:2, in particular from 1.5:1 to 1:1.5.

In the preparation of the binder composition of the present invention, the reaction described above and according to stage (i) can be carried out in an aqueous environment or essentially in the absence of water.

If the described reaction according to stage (i) is carried out in the aqueous phase, the term aqueous phase is understood in the context of the present text as meaning a phase which contains from 10 to 100% by weight of water. If the water content of the aqueous phase is less than 10%, it is preferable in the context of the present invention if the aqueous phase contains a mixture of water and one or more water-miscible solvents, such as THF, methanol, ethanol, propanol, butanol, acetone, methyl ethyl ketone or the like. However, it is also possible to carry out the reaction according to stage (i) in the presence of a mixture of water and a water-immiscible solvent, such as an aromatic solvent, for example toluene.

The above reaction according to stage (i) can be carried out, for example, in the presence of a base. Consequently, organic or inorganic, preferably low molecular weight bases can be used. Examples of suitable bases are NaOH, KOH, ammonia, diethanolamine, mono-, di- or triethylamine, dimethylethanolamine or a mixture of two or more thereof. Good results can be obtained, for example, with ammonia, di- or triethanol or a mixture of two or more thereof.

However, it is also possible to carry out the reaction according to stage (i) in an organic solvent or in the absence of a solvent, for example in the melt. Where the term reaction procedure in an organic solvent or in the absence of a solvent is used in the context of the present invention, it is understood as meaning a reaction procedure which takes place in the presence of less than 10, preferably less than 5 or less than 1, % by weight of water. In a further embodiment of the present invention, at least one block copolymer is used in the novel binder composition, in the preparation of which block copolymer stage (i) was carried out in an organic solvent or in the absence of a solvent, the water content of the reaction mixture being less than 0.5, for example less than 0.3 or less than 0.1, % by weight. In a further embodiment of the present invention, the reaction procedure of stage (i) is carried out in the absence of water, i.e. with a water content of less than 0.001% by weight. Such water contents can be achieved, for example, by using commercially available solvents, as usually employed as organic solvents in free radical polymerizations.

Suitable solvents in the context of the present invention are in principle all polar and nonpolar organic solvents in which the corresponding polymers and preferably also the polymers forming are soluble, if necessary at elevated temperatures. Suitable solvents are, for example, C3- to C10-alkanes, cyclohexane, decalin, acetone, methyl ethyl ketone, diisobutyl ketone, tetrahydrofuran, dioxane, benzene, toluene, glycols, such as ethylene glycol or triethylene glycol, glycol ethers in which some or all of the terminal groups have been blocked, such as ethylene glycol monomethyl ether, ethyl acetate, methanol or ethanol or the higher homologs of the alkanols of up to 18 carbon atoms (if necessary as cosolvent) or mixtures of two or more thereof.

The reaction according to stage (i) is carried out in general at above room temperature and below the decomposition temperature of the monomers, preferably a temperature range of from 50 to 150° C., particularly preferably from 70 to 120° C., in particular from 80 to 110° C., being chosen.

The reaction according to stage (i) is carried out in general at from 1 to 300, for example from about 1.5 to 100 or from about 2 to about 20, bar.

Although there are no restrictions at all with regard to the molecular weight distribution, a reaction product which has a molecular weight distribution Mw/Mn, measured by gel permeation chromatography using polystyrene as standard, of ≦4, preferably ≦3, particularly preferably ≦2, in particular ≦1.5 and in individual cases also ≦1.3 can be obtained in the reaction according to (i). The molecular weights of the reaction product (A) are controllable within wide limits by the choice of the ratio of monomers (a) to compounds (I) to free radical initiator. In particular, the content of compound (I) determines the molecular weight and does so by virtue of the fact that the greater the proportion of compound (I), the lower the molecular weight obtained.

The reaction product to be obtained in the reaction according to stage (i) is, for example, directly further processed for preparing the block copolymers contained in the novel binder composition. Within the scope of the present invention, it is however also possible first to store the reaction product according to stage (i) temporarily and not to carry out further processing until later on. In the further processing, the reaction product according to stage (i) serves as a macroinitiator for a further reaction, which is defined below as stage (ii).

In the subsequent stage (ii), the reaction product of stage (i) is reacted with a further monomer capable of free radical homopolymerization or copolymerization or with a mixture of two or more such monomers. In such a reaction according to stage (ii), the reaction product of stage (i) is accordingly reacted with at least one freely selectable monomer (b) which is capable of free radical homopolymerization or copolymerization and differs from the monomer (a) used in stage (i) in at least one of the properties defined further above. If a mixture of two or more monomers was used in the reaction according to stage (i), a further monomer (b) can be used in stage (ii), but it is just as possible to use a mixture of two or more monomers (b).

All that is critical in this context is that the monomers which were used in stage (i) differ from the monomers used in stage (ii) in that the block obtained in the reaction according to stage (i) differs from the block obtained in stage (ii) in at least one of the abovementioned properties.

In principle, suitable monomers (b) are the monomers stated above in the description of the monomers (a).

The reaction according to stage (ii) is carried out in principle under the usual conditions for a free radical polymerization, it being possible to effect the reaction according to stage (i) in the aqueous phase, in a solvent or in the absence of a solvent.

In the process described, stages (i) and (ii) can be carried out separately from one another in terms of both space and time, first stage (i) and then stage (ii) being carried out. Stages (i) and (ii) can also be carried out in succession in only one reaction vessel, i.e. first at least one monomer (a) is partially or completely polymerized by the free radical method, depending on the desired use or the desired properties, in the presence of a compound of the formula (I) and then at least one monomer (b) is added and is likewise polymerized by the free radical method.

However, in the present invention, it is also possible for a monomer mixture comprising at least one monomer (a) and at least one monomer (b) to be used from the beginning and to be reacted in the presence of the compound (I).

It is assumed that first the compound (I) reacts with the one or more monomers (a) and then the reaction product (A) formed therefrom also reacts with the monomer (b) above a specific molecular weight.

Depending on the reaction procedure, it is possible, according to the invention, to prepare polymers functionalized at the terminal groups, block or multiblock copolymers and gradient copolymers, star polymers, graft copolymers and branched copolymers.

It is also envisaged that the polymer (B) obtained in stage (ii) is reacted in a further reaction stage (iii) with a further monomer (c), where the monomer (c) may likewise be selected from, for example, the abovementioned list. The reaction is carried out as described above for stages (i) and (ii). The novel process can accordingly be carried out with any desired number of stages, limited essentially only by the reaction conditions and the material properties of the polymer forming, and correspondingly with any desired number of monomers.

In the preparation of the polymers to be used in the novel binder composition, depending on the desired number of blocks in the block copolymer, the reaction product from stage (ii), the polymer (B), can be reacted in a further reaction stage (iii) with a further monomer (c) or with a mixture of two or more further monomers (c). The monomer (c) or the mixture of two or more monomers (c) can be selected, for example, from the abovementioned list of monomers (a). The reaction is carried out as described above for stages (i) and (ii). By means of this reaction procedure, it is possible to prepare a block copolymer having essentially any desired number of blocks, for example 5, 10, 20, 50 or 100 blocks.

In this context, it is unimportant whether all blocks each have a different monomer composition or whether a block sequence results in which two or more different monomers combine in a specific sequence or are repeated randomly. All that is decisive is that at least two of the blocks have different monomer compositions as defined above.

In the process for the preparation of a block copolymer as used in a novel binder composition, in stage (iii),

(iii) the reaction product (B) obtained in stage (ii) can therefore be reacted under free radical conditions in the presence of at least one monomer (c) capable of free radical homopolymerization or copolymerization, this reaction being, if required, repeated several times in succession with the same or different monomers (c).

It is possible, in a simple manner using an easily obtainable compound of the formula I, to provide block copolymers which have, for example, a hydrophilic block, e.g. a (methjacrylic acid or a C1-4-alkyl (meth)acrylate block, and a further, preferably hydrophobic polymer block, e.g. a block based on vinylaromatic monomers, such as styrene or substituted styrenes, and nonaromatic vinyl compounds, e.g. vinyl acetate, and higher (>C4) alkyl (meth)acrylates. According to the process described, it is, however, also possible, using a compound according to the formula I, to provide block copolymers which have a hydrophobic and subsequently a hydrophilic block.

It has moreover been found that those monomers which have an electron-rich olefinically unsaturated double bond are also capable of free radical homopolymerization or copolymerization by the process described. Examples of such compounds are the vinyl ethers, vinyl esters, for example vinyl acetate, or the N-vinyl compounds, as mentioned above.

In said process, the monomers can be copolymerized essentially in any desired sequence without, for example, having to adhere to a specific sequence of hydrophilic and hydrophobic monomers.

For example, polymers of the following structure, which can be used in the novel binder compositions, can furthermore be prepared: poly((meth)acrylic acid-stat-(meth)acrylate-b-(styrene-stat-(meth)acrylate)), where the term (meth)acrylate refers to alkyl esters of methacrylic acid and acrylic acid.

Specific examples are the following block copolymers: poly(styrene-b-acrylic acid), poly(styrene-b-methyl acrylate), poly(styrene-b-ethyl acrylate), poly(styrene-b-vinyl acetate), poly(styrene-b-methacrylic acid), poly(styrene-b-methyl methacrylate), poly(styrene-b-ethyl methacrylate), poly(hydroxyethyl acrylate-b-methacrylic acid), poly(N-vinylpyrrolidone-b-methyl acrylate), poly(N-vinylpyrrolidone-b-ethyl acrylate), poly(N-vinylpyrrolidone-b-methyl methacrylate), poly(N-vinylpyrrolidone-b-ethyl methacrylate), poly(N-vinylpyrrolidone-b-styrene), poly(N-vinylpyrrolidone-b-vinyl acetate), poly(N-vinylpyrrolidone-b-α-methylstyrene), poly(N-vinylformamide-b-methyl methacrylate), poly(N-vinylformamide-b-ethyl methacrylate), poly(N-vinylformamide-b-vinyl acetate), poly(N-vinylformamide-b-methyl acrylate) or poly(N-vinylformamide-b-ethyl acrylate).

The following may also be used according to the invention: poly(methyl methacrylate-b-(styrene-stat-acrylonitrile)), poly(n-butyl acrylate-b-styrene-b-n-butyl acrylate), poly(styrene-b-n-butyl acrylate-b-styrene), poly(styrene-b-n-butyl acrylate-b-styrene-b-n-butyl acrylate), poly(methyl methacrylate-b-styrene-b-methyl methacrylate-b-styrene), poly(n-butyl acrylate-b-styrene-b-n-butyl acrylate-b-styrene) and the like.

Also suitable are: poly((styrene-s-styrenesulfonic acid sodium salt)-b-methyl methacrylate), poly((styrene-s-styrenesulfonic acid sodium salt)-b-propyl methacrylate), poly((styrene-s-styrenesulfonic acid sodium salt)-b-butyl methacrylate), poly((styrene-s-styrenesulfonic acid sodium salt)-b-ethyl methacrylate), poly((styrene-s-styrenesulfonic acid sodium salt)-b-propyl acrylate), poly((styrene-s-styrenesulfonic acid sodium salt)-b-methyl acrylate), poly((styrene-s-styrenesulfonic acid sodium salt)-b-butyl acrylate), poly((styrene-s-styrenesulfonic acid sodium salt)-b-ethyl acrylate), poly((styrene-s-acrylamido-2-methylpropanesulfonic acid sodium salt)-b-methyl methacrylate), poly((styrene-s-acrylamido-2-methylpropanesulfonic acid sodium salt)-b-propyl methacrylate), poly((styrene-s-acrylamido-2-methylpropanesulfonic acid sodium salt)-b-butyl methacrylate), poly((styrene-s-acrylamido-2-methylpropanesulfonic acid sodium salt)-b-ethyl methacrylate), poly((styrene-s-acrylamido-2-methyl-propanesulfonic acid sodium salt)-b-propyl acrylate), poly((styrene-s-s-acrylamido-2-methylpropanesulfonic acid sodium salt)-b-methyl acrylate), poly((styrene-s-acrylamido-2-methylpropanesulfonic acid sodium salt)-b-butyl acrylate), poly((styrene-s-acrylamido-2-methylpropanesulfonic acid sodium salt)-b-ethyl acrylate), poly((styrene-s-acrylonitrile-acrylamido-2-methyl-propanesulfonic acid sodium salt)-b-styrene); poly((styrene-s-styrene-sulfonic acid sodium salt)-b-styrene), poly((styrene-s-acrylonitrile-s-styrenesulfonic acid sodium salt)-b-styrene), poly((styrene-s-acrylamido-2-methylpropanesulfonic acid sodium salt)-b-styrene), poly((styrene-s-acrylonitrile-s-acrylamido-2-methylpropane-sulfonic acid sodium salt)-b-methyl methacrylate); poly((styrene-s-styrenesulfonic acid sodium salt)-b-methyl methacrylate), poly((styrene-s-acrylonitrile-s-styrene-sulfonic acid sodium salt)-b-methyl methacrylate), poly((styrene-s-acrylamido-2-methylpropanesulfonic acid sodium salt)-b-methyl methacrylate), poly((styrene-s-acrylonitrile-s-acrylamido-2-methylpropanesulfonic acid sodium salt)-b-ethyl methacrylate); poly((styrene-s-styrenesulfonic acid sodium salt)-b-ethyl methacrylate), poly((styrene-s-acrylonitrile-s-styrenesulfonic acid sodium salt)-b-ethyl methacrylate), poly((styrene-s-acrylamido-2-methylpropanesulfonic acid sodium salt)-b-ethyl methacrylate); poly((styrene-s-acrylonitrile-s-acrylamido-2-methylpropanesulfonic acid sodium salt)-b-propyl methacrylate), poly((styrene-s-styrenesulfonic acid sodium salt)-b-propyl methacrylate), poly((styrene-s-acrylonitrile-s-styrenesulfonic acid sodium salt)-b-propyl methacrylate), poly((styrene-s-acrylamido-2-methylpropanesulfonic acid sodium salt)-b-propyl methacrylate), poly((styrene-s-acrylonitrile-s-acrylamido-2-methylpropanesulfonic acid sodium salt)-b-butyl methacrylate); poly((styrene-s-styrenesulfonic acid sodium salt)-b-butyl methacrylate), poly((styrene-s-acrylonitrile-s-styrenesulfonic acid sodium salt)-b-butyl methacrylate), poly((styrene-s-acrylamido-2-methylpropanesulfonic acid sodium salt)-b-butyl methacrylate), poly((styrene-s-acrylonitrile-s-acrylamido-2-methylpropanesulfonic acid sodium salt)-b-methyl acrylate); poly((styrene-s-styrenesulfonic acid sodium salt)-b-methyl acrylate), poly((styrene-s-acrylonitrile-s-styrenesulfonic acid sodium salt)-b-methyl acrylate), poly((styrene-s-acrylamido-2-methylpropanesulfonic acid sodium salt)-b-methyl acrylate), poly((styrene-s-acrylonitrile-s-acrylamido-2-methylpropanesulfonic acid sodium salt)-b-ethyl acrylate); poly((styrene-s-styrenesulfonic acid sodium salt)-b-ethyl acrylate), poly((styrene-s-acrylonitrile-s-styrenesulfonic acid sodium salt)-b-ethyl acrylate), poly((styrene-s-acrylamido-2-methylpropanesulfonic acid sodium salt)-b-ethyl acrylate), poly((styrene-s-acrylonitrile-s-acrylamido-2-methylpropanesulfonic acid sodium salt)-b-propyl acrylate), poly((styrene-s-styrenesulfonic acid sodium salt)-b-propyl acrylate), poly((styrene-s-acrylonitrile-s-styrenesulfonic acid sodium salt)-b-propyl acrylate), poly((styrene-s-acrylamido-2-methylpropanesulfonic acid sodium salt)-b-propyl acrylate), poly((styrene-s-acrylonitrile-s-acrylamido-2-methylpropanesulfonic acid sodium salt)-b-butyl acrylate), poly((styrene-s-styrenesulfonic acid sodium salt)-b-butyl acrylate); poly((styrene-s-acrylonitrile-s-styrenesulfonic acid sodium salt)-b-butyl acrylate) and poly((styrene-s-acrylamido-2-methylpropanesulfonic acid sodium salt)-b-butyl acrylate).

A novel binder composition may comprise, for example, only one of the abovementioned block copolymers. However, it is also envisaged in the present invention that a novel binder composition comprises two or more of said block copolymers.

In addition to said block copolymers, a novel binder composition may also comprise further polymers. Suitable further polymers are, for example, random copolymers prepared by free radical polymerization. Also suitable as further polymers are, for example, polyadducts or polycondensates, such as polyesters, polyethers, polycarbonates, polylactones, polyamides or polyurethanes.

In addition to the abovementioned polymers or the mixture of two or more of the abovementioned polymers, the novel binder compositions also contain at least 2% by weight of a nonmagnetic and nonmagnetizable organic or inorganic solid.

In the context of the present invention, a solid is understood as meaning a substance which is present in solid form at room temperature, i.e. at about 20° C.

Suitable solids in the context of the present invention are all solids whose shape and size permit incorporation of the solids into a novel binder composition. Preferably, the solids which can be used in the present invention are in particle form or in the form of fibers. In the context of the present invention, a particle form is understood as meaning, for example, a spherical shape, needle shape, cube shape, prism shape or the like. Particulate solids as may be used in the present invention preferably have a maximum dimension of about 1 mm, but preferably less, for example about 500 μm at the most.

The dimension of the particulate solids which can be used in the present invention is referred to below as particle size. The term particle size represents an average value. This average value means that about 50% of the particles have a size which is in a range of ±10% of the value stated as the particle size. A value of about 1 nanometer is applicable for the lower limit of the particle size of the solids which can be used in the present invention, if they are present in particle form. In a further preferred embodiment, the particulate solids which can be used in the present invention have a particle size from about 0.5 to about 300 μm.

In a further embodiment of the present invention, the solids may also be present as fibers, fiber mats, fiber braids or chopped fibers. Suitable fibers may have, for example, a length of about 500 μm or more, for example up to about 5 cm. Particularly suitable fibers are chopped fibers having a length of from about 1 mm to about 3 cm.

Suitable nonmagnetic inorganic particulate fillers and pigments are, for example, carbon black, graphite, metals, metal oxides, metal carbonates, metal sulfates, metal nitrides, metal carbides, metal sulfides, carbonates or silicates (for example talc, clay, mica, silica). Examples are TiO2 (rutile or anatase), TiOx, cerium oxide, tin oxide, tungsten oxide, antimony oxide, ZnO, ZrO2, SiO2, Cr2O3, α-Al2O3, β-Al2O3, γ-Al2O3, α-Fe2O3, aluminum hydroxide, goethite, corundum, silicon nitride, titanium carbide, magnesium oxide, boron nitride, molybdenum sulfide, copper oxide, MgCO3, CaCO3, BaCO3, SrCO3, BaSO4, CaSO4, silicon carbide and titanium carbide. These compounds may be present either individually or in combination with one another and are not restricted in shape and size. Compounds need not be present in pure form but may have been surface-treated with other compounds.

Suitable organic fillers are, for example, plastics powders, in particular comprising polyethylene, polypropylene, polystyrene or polyamide. Also suitable are cellulose powder, starch, sawdust or wood chips. Suitable organic pigments are, for example, monoazo pigments, such as C.I. Pigment Brown 25; C.I. Pigment Orange 5, 13, 36 and 67; C.I. Pigment Red I, 2, 3, 5, 8, 9, 12, 17, 22, 23, 31, 48:1, 48:2, 48:3, 48:4, 49, 49:1, 52:1, 52:2, 53, 53:1, 53:3, 57:1, 63, 251, 112, 146, 170, 184, 210 and 245; C.I. Pigment Yellow I, 3, 73, 74, 65, 97, 151 and 183; bisazo pigments, such as C.I. Pigment Orange 16, 34 and 44; C.I. Pigment Red 144, 166, 214 and 242; C.I. Pigment Yellow 12, 13, 14, 16, 17, 81, 83, 106, 113, 126, 127, 155, 174, 176 and 188; anthanthrone pigments, such as C.I. Pigment Red 168 (C.I. Vat Orange 3); anthraquinone pigments, such as C.I. Pigment Yellow 147 and 177; C.I. Pigment Violet 31; anthrapyrimidine pigments, such as C.I. Pigment Yellow 108 (C.I. Vat Yellow 20); quinacridone pigments, such as C.I. Pigment Red 122, 202 and 206; C.I. Pigment Violet 19; quinophthalone pigments, such as C.I. Pigment Yellow 138; dioxazine pigments, such as C.I. Pigment Violet 23 and 37; flavanthrone pigments, such as C.I. Pigment Yellow 24 (C.I. Vat Yellow I); indanthrone pigments, such as C.I. Pigment Blue 60 5 (C.I. Blue 4) and 64 (C.I. Vat Blue 6); isoindoline pigments, such as C.I. Pigment Orange 69; C.I. Pigment Red 260; C.I. Pigment Yellow 139 and 185; isoindolinone pigments, such as C.I. Pigment Orange 61; C.I. Pigment Red 257 and 260; C.I. Pigment Yellow 109, 110, 173 and 185; isoviolanthrone pigments, such as C.I. Pigment Violet 31 (C.I. Vat Violet I); metal complex pigments, such as C.I. Pigment Yellow 117, 150 and 153; C.I. Pigment Green 8; perinone pigments, such as C.I. Pigment Orange 43 (C.I. Vat Orange 7); C.I. Pigment Red 194 (C.I. Vat Red 15); perylene pigments, such as C.I. Pigment Black 31 and 32; C.I. Pigment Red 123, 149, 178 and 179 (C.I. Vat Red 23), 190 (C.I. Vat Red 29) and 224; C.I. Pigment Violet 29; phthalocyanine pigments, such as C.I. Pigment Blue 15, 15:1, 15:2, 15:3, 15:4, 15:6 and 16; C.I. Pigment Green 7 and 36; pyranthrone pigments, such as C.I. Pigment Orange 51; C.I. Pigment Red 216 (C.I. Vat Orange 4); thioindigo pigments, such as C.I. Pigment Red 88 and 181 (C.I. Vat Red I); C.I. Pigment Violet 38 (C.I. Vat Violet 3); triarylcarbonium pigments, such as C.I. Pigment Blue I, 61 and 62; C.I. Pigment Green I; C.I. Pigment Red 81, 81:1 and 169; C.I. Pigment Violet I, 2, 3 and 27; and C.I. Pigment Black I (aniline black); C.I. Pigment Yellow 101 (aldazine yellow); C.I. Pigment Brown 22; vat dyes (except for those mentioned above), such as C.I. Vat Yellow 2, 3, 4, 5, 9, 10, 12, 22, 26, 33, 37, 46, 48, 49 and 50; C.I. Vat Orange I, 2, 5, 9, 11, 13, 15, 19, 26, 29, 30 and 31; C.I. Vat Red 2, 10, 12,13, 14,16, 19, 21, 31, 32, 37, 41, 51, 52 and 61; C.I. Vat Violet 2, 9, 13, 14,15, 17 and 21; C.I. Vat Blue I (C.I. Pigment Blue 66), 3, 5, 10, 12, 13, 14, 16, 17, 18, 19, 20, 22, 25, 26, 29, 30, 31, 35, 41, 42, 43, 64, 65, 66, 72 and 74; C.I. Vat Green 1, 2, 3, 5, 7, 8, 9, 13, 14, 17, 26, 29, 30, 31, 32, 33, 40, 42, 43, 44 and 49; C.I. Vat Brown 1, 3, 4, 5, 6, 9, 11, 17, 25, 32, 33, 35, 38, 39, 41, 42, 44, 45, 49, 50, 55, 57, 68, 72, 73, 80, 81, 82, 83 and 84; C.I. Vat Black 1, 2, 7, 8, 9, 13, 14, 16, 19, 20, 22, 25, 27, 28, 29, 30, 31, 32, 34, 36, 56, 57, 58, 63, 64 and 65; inorganic pigments, in the form of white pigments, such as titanium dioxide (C.I. Pigment White 6), zinc white pigment, pigment grade zinc oxide; zinc sulfide, lithopone, lead white; black pigments, such as iron oxide black (C.I. Pigment Black 11), iron manganese black, spinel black (C.I. Pigment Black 27), carbon black (C.I. Pigment Black 7); colored pigments, such as chromium oxide, chromium oxide hydrate green; chromium green (C.I. Pigment Green 48); cobalt green (C.I. Pigment Green 50); ultramarine green; cobalt blue (C.I. Pigment Blue 28 and 36); ultramarine blue; iron blue (C.I. Pigment Blue 27); manganese blue; ultramarine violet; cobalt and manganese violet; iron oxide red (C.I. Pigment Red 101); cadmium sulfoselenide (C.I. Pigment Red 108); molybdate red (C.I. Pigment 5 Red 104); ultramarine red; iron oxide brown, mixed brown, spinel and corundum phases (C.I. Pigment Brown 24, 29 and 31); chromium orange; iron oxide yellow (C.I. Pigment Yellow 42); nickel titanium yellow (C.I. Pigment Yellow 53; C.I. Pigment Yellow 157 and 164); chromium titanium yellow; cadmium sulfide and cadmium zinc sulfide (C.I. Pigment Yellow 37 and 35); chromium yellow (C.I. Pigment Yellow 34), zinc yellow, alkaline earth metal chromates, Naples yellow; bismuth vanadate (C.I. Pigment Yellow 184); interference pigments, such as metal effect pigments based on coated metal platelets; pearl luster pigments based on metal oxide-coated mica platelets; liquid crystal pigments.

Particularly suitable fibrous solids are inorganic fibers, for example glass fibers, or organic fibers which may be of natural or synthetic origin, glass beads also being particularly suitable. Suitable synthetic organic fibers are, for example, polyester, polyether, polyurethane, polyamide or polyolefin fibers, preferably those fibers which mechanically stabilize the binder composition in the state as used. Suitable natural organic fibers are, for example, cellulose fibers, such as cotton wool, flax, hemp, sisal, coconut fibers and the like.

The novel binder compositions may each contain an individual solid from the solids mentioned above. In the context of the present invention, however, it is also envisaged that the novel binder compositions comprise a mixture of two or more of said solids.

The novel binder compositions contain said solids in an amount of at least about 2% by weight, based on the total binder composition, but preferably in amounts greater than this. For example, the novel compositions may contain the solids in an amount of at least about 5, 10 or 20% by weight or more, for example about 30, 40, 50, 60, 70, 80 or more than 90% by weight, for example up to 98 or 99% by weight.

In addition, the novel binder compositions may also contain dispersants or water or further additives, such as lubricants, solvents, antioxidants, stabilizers, thickeners, rheology assistants, leveling agents, wetting agents or humectants, for example a combination of N-methylpyrrolidone or triethylene glycol monobutyl ether, or mixtures of two or more of said additives. Suitable compounds are to be found, for example, in the technical literature.

In particular, carboxylic acids of about 10 to about 20 carbon atoms, in particular stearic acid or palmitic acid, or derivatives of carboxylic acids, such as their salts, esters or amides, or mixtures of two or more thereof, may be used as lubricants.

The novel binder compositions can be obtained by mixing the abovementioned polymers with the corresponding solids. The present invention therefore also relates to a process for the preparation of a novel binder composition, in which a block copolymer which can be prepared by free radical polymerization and has at least two blocks of different monomer compositions is dispersed with at least one solid defined in this text.

For the preparation of the novel binder compositions, a block copolymer which can be prepared by free radical polymerization and comprises at least two blocks of different monomer compositions, or a mixture of two or more such block copolymers, can therefore be dispersed together with a magnetic pigment or a mixture of two or more solids, for example as a mixture with one or more solvents, if required, together with dispersants, further binders and further additives, such as lubricants. In a preferred embodiment, the main components in the novel binder composition, i.e. in particular the solids and the polymeric binders, are first mixed with the addition of a little solvent to give a pasty mass and are then thoroughly mixed with one another, for example by kneading, and only thereafter dispersed.

Thus, the novel binder composition can then be prepared, for example in a dispersing apparatus, such as a tubular ball mill or a stirred ball mill, from a particulate solid and the further ingredients of the binder composition which have been converted into a paste, or a solution of the binders used, preferably in an organic solvent, with the addition of lubricant and possibly small amounts of a dispersant.

The present invention therefore also relates to a process for the preparation of a binder composition, in which a block copolymer which can be prepared by free radical polymerization and comprises at least two blocks of different monomer compositions, and at least 2% by weight of at least one nonmagnetic and nonmagnetizable inorganic or organic solid are mixed or at least 2% by weight of at least one nonmagnetic and nonmagnetizable inorganic or organic solid are already present during the preparation of the block copolymer which can be prepared by free radical polymerization.

The present invention also relates to the use of a novel binder composition or of a binder composition prepared by the novel process for the preparation of finishes, surface coatings, coating materials, inks, for example for inkjet printers, printing inks or rustproofing agents or for coloring plastics, paper, textiles, cement, concrete, ceramic, glass, enamel, cosmetics or foods.

The novel binder composition may be present in the form of aqueous dispersions, as solids, melts or as solutions.

For the preparation of the binder compositions, for example, the filler or the pigment in the form of a water-containing press cake or in the form of a dry pigment or filler powder is mixed together with one or more novel dispersants in water, organic solvents or as such and is dispersed or kneaded in a suitable apparatus. The mixture obtained can then be milled in a mill to establish the desired particle size distribution. Further assistants can then be added. Finally, the final formulation is prepared by adding, if desired, corresponding amounts of water or organic solvents and, if required, further additives from among those described above. The formulation is then treated, for example, with the aid of a filtration apparatus with fines removal within the range from about 10 to about 1 μm and, if required, then with a further filtration apparatus with fines removal within the range from about 1 to about 0.5 μm.

The Examples which follow illustrate the present invention.

### EXAMPLES

### Example 1

Synthesis of a Polymeric Reaction Product from Acrylic Acid and Styrene

224 g of water and 15.4 g of a 25% strength ammonia solution in water were heated to 80° C. 3 g of 1,1-diphenylethene (dissolved in 45 g of acrylic acid) and 4.73 g of ammonium peroxodisulfate (dissolved in 22.4 g of water) were then simultaneously added dropwise in the course of 30 minutes through 2 dropping funnels. The batch was kept at 80° C. for a total of 4 hours. 25 g of water, 40 ml of a 25% strength ammonia solution in water and 38 g of styrene were added to 101 g of this batch, which was then kept at 90° C. for 13 hours. A white water-swellable polymer was obtained.

### Example 2

Synthesis of a Polymeric Reaction Product from Methyl Methacrylate and Styrene

125 g of a 25% strength ammonia solution in 125 g of water were initially taken and kept at 90° C. in an oil bath. 6 g of 1,1-diphenylethene (dissolved in 125 g of methyl methacrylate) and 4.73 g of ammonium peroxodisulfate (dissolved in 22.4 g of water) were then simultaneously added dropwise in the course of 60 minutes through 2 dropping funnels. A further 4.73 g of ammonium peroxodisulfate (dissolved in 22.4 g of water) were then added dropwise in the course of one hour. The batch was then kept at 90° C. for a further hour. 65 g of styrene were added to this batch and the oil bath temperature was increased to 100° C. for 4 hours.

### Example 3

Synthesis of a Polymeric Reaction Product from Methacrylic Acid and Hydroxyethyl Acrylate

112 g of water and 112 g of a 25% strength ammonia solution in water were initially taken and heated to 90° C. 9.46 g of ammonium peroxodisulfate (dissolved in 45 g of water) and 6 g of 1,1-diphenylethene (dissolved in 107.5 g of methacrylic acid) were then rapidly added dropwise, the former in the course of 30 minutes. A further 9.46 g of ammonium peroxodisulfate (dissolved in 45 g of water) were then added dropwise in the course of 30 minutes. After the addition, the batch was kept at 90° C. for 5 hours. 1 mol of hydroxyethyl acrylate was then added and the batch was kept at 90° C. for 5 hours.

### Example 4

Synthesis of a Polymeric Reaction Product from Methyl Methacrylate and N-vinylpyrrolidone

360 g of water were initially taken and kept at 75° C. Thereafter, 10 g of 1,1-diphenylethene (dissolved in 200 g of methyl methacrylate) and 10.3 g of ammonium peroxodisulfate (dissolved in 100 g of water), in the course of 60 minutes, and 9.2 g of a 25% strength ammonia solution (dissolved in 100 g of water), in the course of 90 minutes, were simultaneously added dropwise. The batch was then kept at 75° C. for a further 3 hours. Thereafter, 20.4 g of N-vinylpyrrolidone were added to 100 g of the dispersion described above, and the batch was kept at 75° C. for 6 hours.

### Example 5

Synthesis of a Polymeric Reaction Product from Methyl Methacrylate and N-vinylformamide

360 g of water were initially taken and kept at 75° C. Thereafter, 10 g of 1,1-diphenylethene (dissolved in 200 g of methyl methacrylate) and 10.3 g of ammonium peroxodisulfate (dissolved in 100 g of water), in the course of 60 minutes, and 9.2 g of a 25% strength ammonia solution (dissolved in 100 g of water), in the course of 90 minutes, were simultaneously added dropwise. The batch was then kept at 75° C. for a further 3 hours. Thereafter, 25 g of N-vinylformamide were added to 100 g of the dispersion described above, and the batch was kept at 75° C. for 6 hours.

### Example 6

Synthesis of a Polymeric Reaction Product from Methyl Methacrylate and Hydroxyethyl Acrylate

360 g of water were initially taken and kept at 90° C. Thereafter, 10 g of 1,1-diphenylethene (dissolved in 200 g of methyl methacrylate) and 10.3 g of ammonium peroxodisulfate (dissolved in 100 g of water), in the course of 60 minutes, and 9.2 g of a 25% strength ammonia solution (dissolved in 100 g of water), in the course of 90 minutes, were simultaneously added dropwise. The batch was then kept at 90° C. for a further 3 hours. Thereafter, 25 g of hydroxyethyl acrylate were added to 100 g of the dispersion described above, and the batch was kept at 90° C. for 6 hours.

### Example 7

Synthesis of a Polymeric Reaction Product from Methyl Methacrylate, Acrylonitrile and Styrene

360 g of water were initially taken and kept at 90° C. Thereafter, 10 g of 1,1-diphenylethene (dissolved in 200 g of methyl methacrylate) and 10.3 g of ammonium peroxodisulfate (dissolved in 100 g of water), in the course of 60 minutes, and 9.2 g of a 25% strength ammonia solution (dissolved in 100 g of water), in the course of 90 minutes, were simultaneously added dropwise. The batch was then kept at 90° C. for a further 3 hours. Thereafter, 17.2 g of styrene and 1 g of acrylonitrile were added to 100 g of the dispersion described above, and the batch was kept at 90° C. for 6 hours.

### Example 8

Synthesis of a Polymeric Reaction Product from N-butyl Acrylate and Styrene

360 g of water were initially taken and the oil bath was heated to 90° C. 11.1 g of 1,1-diphenylethene (dissolved in 256 g of n-butyl acrylate) and 10.7 g of sodium peroxodisulfate (dissolved in 100 g of water), in the course of 180 minutes, and 2.3 g of sodium hydroxide (dissolved in 100 g of water), in the course of 120 minutes, were then simultaneously added dropwise through 3 dropping funnels. The oil bath was kept at 90° C. for a total of 6 hours. After the aqueous phase had been separated off, 138 g of styrene were added to the remaining polymer and the oil bath was kept at 115° C. for 6 hours. Thereafter, 169 g of n-butyl acrylate were added and the oil bath was kept at 115° C. for 6 hours.

### Example 9

Synthesis of a Polymeric Reaction Product from Methyl Methacrylate and Styrene

180 g of water were initially taken and kept at 90° C. Thereafter, from 3 dropping funnels, 3 g of cis-stilbene (dissolved in 50 g of methyl methacrylate) and 5 g of a 25% strength ammonia solution (dissolved in 50 g of water) were added dropwise in the course of 60 minutes and at the same time 5.1 g of ammonium peroxodisulfate (dissolved in 50 g of water) were added dropwise in the course of 90 minutes. The batch was then kept at 90° C. for a further 4.5 hours. A polymer having Mw=54,200 g/mol and a polydispersity of 2.4 was obtained. 70 g of the polymer dispersion described above were heated to 115° C. and 50 g of styrene were metered in. The batch was then kept at 115° C. for 6 hours.

### Example 10

Synthesis of a Polymeric Reaction Product from Methyl Methacrylate and Styrene

180 g of water were initially taken and kept at 90° C. Thereafter, from 3 dropping funnels, 3 g of trans-stilbene (dissolved in 50 g of methyl methacrylate) and 5 g of a 25% strength ammonia solution (dissolved in 50 g of water) were added dropwise in the course of 60 minutes and at the same time 5.1 g of ammonium peroxodisulfate (dissolved in 50 g of water) were added dropwise in the course of 90 minutes. The batch was then kept at 90° C. for a further 4.5 hours. A polymer having Mw=46,800 g/mol and a polydispersity of 2.9 was obtained. 70 g of the polymer dispersion described above were heated to 115° C. and 50 g of styrene were metered in. The batch was then kept at 115° C. for 6 hours. A polymer having Mw=168,000 g/mol and a polydispersity of 4.2 was obtained.

### Example 11

Synthesis of a Polymeric Reaction Product from Methyl Methacrylate

180 g of water were initially taken and kept at 90° C. Thereafter, from 3 dropping funnels, 5 g of 4,4-vinylidenebis(N,N-dimethylaniline) (dissolved in 100 g of methyl methacrylate) and 4.6 g of a 25% strength ammonia solution (dissolved in 100 g of water) were added dropwise in the course of 60 minutes and at the same time 5.1 g of ammonium peroxodisulfate (dissolved in 100 g of water) were added dropwise in the course of 90 minutes. The batch was kept at 90° C. for a further 4 hours. A polymer having Mw=2150 g/mol and a polydispersity of 1.2 was obtained.

### Example 12

Synthesis of a Polymeric Reaction Product from Methyl Methacrylate

360 g of water were initially taken and kept at 90° C. Thereafter, 10 g of 1,1-diphenylethene (dissolved in 200 g of methyl methacrylate) and 10.3 g of ammonium peroxodisulfate (dissolved in 100 g of water) were added dropwise in the course of 60 minutes and at the same time 9.2 g of a 25% strength ammonia solution (dissolved in 100 g of water) were added dropwise in the course of 90 minutes. The batch was then kept at 90° C. for a further 3 hours.

For the dispersing tests, the polymer dispersions were used directly (aqueous solids dispersions) or the polymers were dried and were dissolved in a solvent or in a solvent mixture.

Dispersing Tests

The corresponding polymer from the synthesis examples (numbering corresponds) was mixed in aqueous dispersion (solids content 20%) with the colored pigment at room temperature, 20 g of SAZ grinding balls were added and shaking was carried out for 1 h in a Red Devil. The solids ratio of polymer to colored pigment was 20/1 (weight ratio). The dispersion was then assessed visually (Table 1). Polymer 12 is a polymethyl methacrylate prepared by the DPE method.

TABLE 1

| | | | | Polymethyl |
|---|---|---|---|---|
| | | | | methacrylate |
| | | | | (Comparative |
| Pigment | Polymer 2 | Polymer 6 | Polymer 12 | Example) |
| Heliogen Blue | Liquid | Liquid | Solid | No dispersing |
| L 6920 | dispersion | dispersion | dispersion | effect at all |
| | stable for | stable for | stable for | |
| | at least | at least | at least | |
| | 24 h | 24 h | 24 h | |
| Paliogen Red | Liquid | Solid | Solid | No dispersing |
| L 3885 | dispersion | dispersion | dispersion | effect at all |
| | stable for | stable for | stable for | |
| | at least | at least | at least | |
| | 24 h | 24 h | 24 h | |
| Paliotol | Dispersion | Solid | Solid | No dispersing |
| Yellow | unstable | dispersion | dispersion | effect at all |
| L 2140 HD | | stable for | stable for | |
| | | at least | at least | |
| | | 24 h | 24 h | |
| Paliogen | Liquid | Solid | Solid | No dispersing |
| Maroon | dispersion | dispersion | dispersion | effect at all |
| L 3980 | stable for | stable for | stable for | |
| | at least | at least | at least | |
| | 24 h | 24 h | 24 h | |

The dispersions shown in Table 1 were then diluted 20 times with water and the dispersion was again assessed visually (Table 2).

TABLE 2

| | | | | Polymethyl |
|---|---|---|---|---|
| | | | | methacrylate |
| | | | | (Comparative |
| Pigment | Polymer 2 | Polymer 6 | Polymer 12 | Example) |
| Heliogen Blue | Liquid | Liquid | Liquid | No dispersing |
| L 6920 | dispersion | dispersion | dispersion | effect at all |
| | stable for | stable for | stable for | |
| | at least | at least | at least | |
| | 24 h | 24 h | 24 h | |
| Paliogen Red | Liquid | Dispersion | Dispersion | No dispersing |
| L 3885 | dispersion | unstable | unstable | effect at all |
| | stable for | | | |
| | at least | | | |
| | 24 h | | | |
| Paliotol | Dispersion | Liquid | Liquid | No dispersing |
| Yellow | unstable | dispersion | dispersion | effect at all |
| L 2140 HD | | stable for | stable for | |
| | | at least | at least | |
| | | 24 h | 24 h | |
| Paliogen | Liquid | Liquid | Dispersion | No dispersing |
| Maroon | dispersion | dispersion | unstable | effect at all |
| L 3980 | stable for | stable for | | |
| | at least | at least | | |
| | 24 h | 24 h | | |

We claim:

1. A binder composition, at least containing a block copolymer which can be prepared by free radical polymerization and comprises at least two blocks of different monomer compositions, and at least 2% by weight of at least one nonmagnetic and nonmagnetizable inorganic or organic solid.

2. A binder composition as claimed in claim 1, wherein the water content of the binder composition is less than 10% by weight.

3. A binder composition as claimed in claim 1 or 2, wherein the block copolymer comprises from two to ten blocks.

4. A binder composition as claimed in any of claims 1 to 3, wherein the block copolymer was prepared by a process at least comprising the following stage (i):
(i) reaction, under free radical conditions, of a reaction mixture comprising
at least one monomer (a) capable of free radical polymerization,
at least one free radical initiator and
a compound of the formula (I) 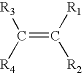
where R1 to R4, independently of one another in each case, are hydrogen, an in each case unsubstituted or substituted alkyl radical, cycloalkyl radical, aralkyl radical, an unsubstituted or substituted aromatic hydrocarbon radical, with the proviso that at least two of the radicals R1 to R4 are an unsubstituted or substituted aromatic hydrocarbon radical, or R1 and R2 or R3 and R4, in pairs in each case, form a substituted or unsubstituted aromatic hydrocarbon having 6 to 18 carbon atoms and a functional group which has, conjugated with the C—C double bond in the formula I, a multiple bond between a carbon atom and a hetero atom, a reaction product (A) being obtained, and
(ii) reaction of the reaction product (A) obtained in stage (i), under free radical conditions, with at least one monomer (b) capable of free radical homopolymerization or copolymerization, a reaction product (B) being obtained.

5. A binder composition as claimed in claim 4, wherein 10% by weight of water or less is present in the reaction mixture during the reaction according to stage (i).

6. A binder composition as claimed in claim 4 or 5, stage (i) being carried out at from 1 to 300 bar.

7. A binder composition as claimed in any of claims 4 to 6, wherein the amount of free radical initiator for the at least one monomer (a) is from 0.5 to 50% by weight, based on the total amount of the initiator and of the monomer (a).

8. A binder composition as claimed in any of claims 4 to 7, wherein diphenylethylene, an alkoxydiphenylethylene, dinaphthylethylene, 4,4-vinylidenebis(N,N-dimethylaniline), 4,4-vinylidenebis(1-aminobenzene), cis-stilbene, trans-stilbene, methyl α-phenylacrylate, methyl α-phenyl-methacrylate, α-phenylacrylonitrile, α-phenylmethacrylonitrile or a mixture of two or more thereof is used as a compound of the formula (I).

9. A binder composition as claimed in any of claims 4 to 8, wherein the reaction mixture comprises, as a first monomer (a), styrene, acrylic or methacrylic acid, a C1- to C4-alkyl or C1- to C4-hydroxyalkyl acrylate or methacrylate, vinyl acetate, a substituted or unsubstituted vinylpyrrolidone, a mixture of two or more thereof, or a mixture of one such first monomer (a) with at least one further monomer capable of free radical homopolymerization or copolymerization.

10. A binder composition as claimed in any of claims 4 to 9, wherein 5% by weight of water or less is present in the reaction mixture during the reaction.

11. A binder composition as claimed in any of claims 4 to 10, wherein the block copolymer was prepared by a process at least comprising the following stage (iii):
(iii) the reaction product (B) obtained in stage (ii) is reacted under free radical conditions in the presence of at least one monomer (c) capable of free radical homopolymerization or copolymerization, this reaction being, if required, repeated several times in succession with the same or different monomers (c).

12. A process for the preparation of a binder composition, in which a block copolymer which can be prepared by free radical polymerization and comprises at least two blocks of different monomer compositions, and at least 2% by weight of at least one nonmagnetic and nonmagnetizable inorganic or organic solid are mixed or at least 2% by weight of at least one nonmagnetic and nonmagnetizable inorganic or organic solid are already present during the preparation of the block copolymer which can be prepared by free radical polymerization.

13. The use of a binder composition as claimed in any of claims 1 to 10 or of a binder dispersion prepared as claimed in claim 12 for the preparation of finishes, surface coatings, coating materials, inks, for example for inkjet printers, printing inks or rustproofing agents or for coloring plastics, paper, textiles, cement, concrete, ceramic, glass, enamel, cosmetics and foods.
